(19) United States
(12) Patent Application Publication
(10) Pub. No.: US 2026/0328009 A1
(43) Pub. Date: Oct. 22, 2026

(54) METHOD, APPARATUS AND SYSTEM FOR MONITORING WATER QUALITY IN A BATHING UNIT SYSTEM

(71) Applicant: GECKO ALLIANCE GROUP INC., Québec (CA)

(72) Inventors: Guillaume Tremblay, Québec (CA); Justin Miller, San Diego, CA (US); Josh Kennedy, La Jolla, CA (US); Scott Eklund, San Diego, CA (US)

(73) Assignee: GECKO ALLIANCE GROUP INC., Québec (CA)

(21) Appl. No.: 19/720,627

(22) Filed: Jun. 25, 2026

Related U.S. Application Data
(62) Division of application No. 18/505,625, filed on Nov. 9, 2023.

(51) Int. Cl. E04H 4/12; A61H 33/00

(52) U.S. Cl. CPC E04H 4/1209; A61H 33/005; A61H 33/6047; A61H 2033/0079

(57) ABSTRACT

A water quality monitoring system is provided for a bathing unit system including a pump and a controller for controlling operations of the pump. The water quality monitoring system comprises: (i) a monitoring device to be positioned in-line within a circulation system of the bathing unit for obtaining water quality measurements; and (ii) a communication module configured to establish a communication channel with a remote server over a computer network for performing an analysis of water quality. The communication module is programmed for: (a) selectively transmitting the water quality measurements obtained by the monitoring device such that at least some measurements obtained when the pump is deactivated are omitted from transmissions made to the remote server; and/or (b) transmitting the water quality measurements to the remote server concurrently with tags conveying the activation status for the pump when the water quality measurements were obtained.

This U.S. Non-Provisional Patent Application is a Divisional of U.S. Patent Application 18/505,625 filed Nov., 2023, the entire disclosure of which is incorporated herein by reference.

### TECHNICAL FIELD

The present invention relates generally to the monitoring of water quality in bodies of water, and more specifically, to a method, device and system for monitoring water chemistry in bodies of water, including for example monitoring oxidation-reduction potential (ORP) level, pH (PH) levels, in a body of water such as in bathing units, including, but not limited to, a swimming pool, a spa, a hot tub, and other sports, recreational and therapeutic bodies of water.

### BACKGROUND

A bathing unit, such as for example a spa or pool, typically includes various components used in the operation of the bathing unit system such as a water holding receptacle, pumps to circulate water in a piping system, a heating module to heat the water, a filter system, an air blower, a lighting system, and a control system for activating and managing the various parameters of the bathing unit components. The circulation system pumps water from the water holding receptacle through the filter system to maintain the body of water at sanitary conditions. In particular, the water passes through the filter system to reduce the accumulation of foreign material, such as hair, soil, or solids, in the pool or spa.

In addition to filtering, bathing unit systems also require regular sanitization in order to maintain hygienic conditions. Allowing sanitation agent levels to either fall below or rise above required levels may result in decreased efficiency of the system. Low levels of chemical sanitizer in the bathing unit can contribute to algae blooms, bacterial breakouts, cloudiness in the water, and chemical imbalances. If left untreated, water-borne bacteria can afflict users of the bathing units with a variety of health problems and illnesses, such as pseudomonas, rashes, hot tub lung, ear infections, etc.

Water sanitation is well known and long practiced. Typical sanitation regimens and processes rely on chemical sanitizer to provide disinfecting action. Halogens, and in particular free chlorine and bromine, have recently been the chemicals of choice for treating recreational reservoir water.

Conventional sanitizer-based systems, to be effective, require that the concentration of sanitizer (chlorine or bromine for example) be maintained within a specified range, which is typically between 3ppm (parts per million) and 5ppm. Maintaining a suitable concentration of sanitizer in the bathing unit typically requires the user to perform periodic measurements for example by using water testing kits and then taking action to adjust the concentration of the sanitation species so that it lies within the desired specified concentration range. Using these measurements, the user may for example add water to reduce the concentration of sanitizer and/or may cause an action to take place to increase the concentration of sanitizer. This is a lengthy process which is not always diligently followed by the user, often resulting in less than ideal water conditions.

Some owners of pools and spas try to monitor, measure, and manage the chemical levels and quality of the pool/spa water by utilizing chemical testing kits, while other owners rely on third party services. However, these approaches can be manually intensive, time-consuming, limited in operating range, and lack data processing power. Additionally, some of these options are susceptible to human error, while third party services can be relatively expensive.

One approach to monitor, measure, and manage the water quality in a pool or spa includes monitoring and measuring characteristics of the water in a circulation system of the pool/spa. However, monitoring and measuring characteristics of the water in a pool or spa circulation system can be challenging as it is generally desired for the water being tested to be representative of the entire pool or spa. Particularly, when the pool or spa pump is inactive, e.g., the pool or spa pump has not been running, the pool or spa water in the plumbing system can be stagnant and affected by environmental factors at a different rate compared to water in the pool or spa body. For example, stagnant water may skew certain chemical readings and provide incorrect data to a monitoring system. That is, the stagnant water may not be an accurate representation of the entire pool or spa. However, when the pool or spa pump is active and water is being circulated through the circulation system, the water in the circulation system is not stagnant and is therefore less likely to be affected by environmental factors at a different rate compared to water in the pool or spa body. Accordingly, the quality of the water circulating through the pool or spa circulation system may be a more accurate representation of the water quality of the entire pool or spa.

U.S. Patent Application Publication No. US 2022/0388871 A1 (“the ‘871 Application”) and U.S. Patent Application Publication No. US 2020/0271635 A1 (“the ‘635 Application”) disclose automated water quality monitoring systems that rely upon manually entered pump activation schedules, utilize vibration sensors to remotely detect vibrations from the pool/spa pump, or include a flow switch in the water quality monitor itself, in order to infer whether the pool/spa pump is active, and thus circulating water through the circulation system of the pool/spa, when water quality measurements are obtained. However, these methods of inferring pump activation have potential drawbacks. For example, relying upon a manually entered pump activation schedule is prone to human error in the entry of the schedule and/or when activation of the pump otherwise deviates from the schedule (e.g., due to manual activation/deactivation of the pump). On the other hand, including a flow switch in the water quality monitor or utilizing vibration sensors to detect vibrations from the pump potentially increase the complexity and/or cost of the water quality monitoring system due to the inclusion of the flow switch or sensors. The use of flow switch or sensors may introduce some potential reliability problems given that they require the use of mechanical devices, which may malfunction or fail. In addition, there is an increasing trend towards quieter pumps that operate with very little sound and/or vibration, which means that activation of the pump may not be easily detectable or may require extremely sensitive vibrations sensors that are more costly.

Against the background described above, there is a need in the industry to provide a method, device and system for monitoring water quality in bathing units that alleviate at least in part the problems associated with existing methods, devices and systems.

### SUMMARY

In accordance with a general aspect, a water quality monitoring system is provided for a bathing unit system including a pump and a controller for controlling operations of the pump. The water quality monitoring system comprises: (i) a monitoring device to be positioned in-line within a circulation system of the bathing unit system for obtaining water quality measurements; and (ii) a communication module configured to establish a communication channel with a remote server over a computer network for performing an analysis of water quality. The communication module is programmed for: (a) selectively transmitting the water quality measurements obtained by the monitoring device such that at least some measurements obtained when the pump is deactivated are omitted from transmissions made to the remote server; and/or (b) transmitting the water quality measurements to the remote server concurrently with tags conveying the activation status for the pump when the water quality measurements were obtained.

In accordance with another general aspect, a water quality monitoring system is provided for a bathing unit system, the bathing unit system including a bathing receptacle, a set of bathing unit components including a pump and a bathing unit controller for issuing signals for controlling operations of the set of bathing unit components, the pump being configured for alternating between an activated state and a deactivated state in response to control signals received from the bathing unit controller, wherein in the activated state the pump is configured for causing water to circulate through a circulation system of the bathing unit system. The water quality monitoring system comprises:
a. a monitoring device configured to be positioned in-line with the circulation system of the bathing unit system, the monitoring device comprising at least one sensor configured to obtain water quality measurements conveying one or more characteristics of water within the circulation system;
b. a communication module in communication with the monitoring device for receiving the water quality measurements and with the bathing unit controller, the communication module receiving operational information conveying status information for one or more bathing unit components in the set of bathing unit components, the status information including information conveying an activation status for the pump, the activation status for the pump conveying one of the activated state and the deactivated state;
c. the communication module being configured to establish a communication channel with a remote server over a computer network and being programmed for selectively transmitting the water quality measurements obtained by the sensor of the monitoring device to the remote server at least in part by processing the status information such that at least some of the water quality measurements obtained by the monitoring device when the activation status for the pump conveys that the pump is in the deactivated state are omitted from transmissions made to the remote server.

In specific practical implementations, the at least one sensor of the monitoring device may include at least one of: a pH sensor, an oxidation-reduction potential sensor, a turbidity sensor, an alkanity sensor or a temperature sensor.

In specific practical implementations, the communication module may be a device separate from the bathing unit controller or, alternatively, may be an integral part of the bathing unit controller.

Advantageously, by using the pump activation status to omit at least some water quality measurements taken when the pump was inactive, water quality measurements that are more representative of the water in the bathing unit receptacle may be taken into account and sent for processing to a remote server. In addition, the use of a signal provided by the bathing unit controller and conveying the pump activation status reduces potential inaccuracies present in conventional systems in determining the relevance of water quality measurements in the circulation system.

In some alternate specific implementations, at least one of the communication module, the monitoring device or the remote server may be configured for issuing a signal to the bathing unit controller requesting activation of the pump for the purpose of obtaining water quality measurements. For example, the communication module or the monitoring device may be configured for periodically taking water quality measurements, say every 15min/30min/1h. In such an embodiment, if the pump is inactive when water quality measurements are to be taken, the communication module or the monitoring device are configured for issuing a signal to the bathing unit controller requesting activation of the pump. The bathing unit controller may be responsive to such a signal requesting activation of the pump to issue a signal an activate the pump for a time duration sufficient to allow water quality measurements to be taken and sent by the communication module.

In some specific implementations, the communication module may further be programmed for receiving water quality analysis information from the remote server and for transmitting the water quality analysis information to the bathing unit controller, the water quality analysis information conveying at least one of:
i. water quality analysis data derived at least in part by processing the water quality measurements transmitted to the remote server; or
ii. recommendations to initiate one or more actions in connection with regulating water quality within the bathing unit system derived at least in part by processing the water quality measurements transmitted to the remote server, the recommendations conveying at least one of an addition of an amount of sanitizer to the bathing unit system, an addition of a PH increaser solution, an addition of a PH reducer solution or an addition of an amount of water the bathing unit system.

In some specific implementations, the water quality monitoring system may include the remote server, wherein the remote server includes an analytics engine configured for processing the water quality measurements to derive water quality analysis information conveying at least one of: (i) water quality analysis data; or (ii) recommendations to initiate one or more actions for regulating water quality within the bathing unit system, the recommendations conveying at least one of an addition of an amount of sanitizer to the bathing unit system, an addition of a PH increaser solution, an addition of a PH reducer solution or an addition of an amount of water the bathing unit system. In some implement the server may be configured for transmitting the water quality analysis information to at least one of (a) the communication module of the water quality monitoring system; or (b) a user device associated with a user of the bathing unit system. The user device may include, for example but without being limited to, a smartphone, a tablet, a computer or a top-side bathing unit control panel.

In some specific implementations, the communication module may further be programmed for transmitting the water quality measurements to the bathing unit controller concurrently with a tag conveying the activation status for the pump when the water quality measurements were obtained.

In some specific implementations, the set of bathing unit components may include a sanitizer in fluid communication with the circulation system, the sanitizer being configured for alternating between an activated state and a deactivated state in response to control signals received from the bathing unit controller, wherein in the activated state the sanitizer is configured for adding a sanitizing agent to the water circulating through the circulation system. The status information conveyed by the operational information received by the communication device from the bathing unit controller may further include information conveying an activation status for the sanitizer, the activation status for the sanitizer conveying one of the activated state and the deactivated state. In such specific implementation, the communication module may be further programmed for: (i) transmitting the water quality measurements to the remote server concurrently with a tag conveying the activation status for the sanitizer when the water quality measurements were obtained; and/or (ii) selectively transmitting the water quality measurements to the remote server at least in part by processing the status information such that at least some water quality measurements obtained by the monitoring device when the sanitizer is in the activated state are omitted from transmissions made to the remote server.

In some specific implementations, the set of bathing unit components may include a heater in fluid communication with the circulation system for heating the water within the circulation system, the heater being configured for alternating between an activated state and a deactivated state in response to control signals received from the bathing unit controller, wherein in the activated state the heater is configured for heating water in the circulation system. The status information conveyed by the operational information received by the communication device from the bathing unit controller may further include information conveying an activation status for the heater, the activation status for the heater conveying one of the activated state and the deactivated state. In such specific implementation, the communication module may be further programmed for transmitting the water quality measurements to the remote server concurrently with a tag conveying the activation status for the heater when the water quality measurements were obtained.

In some specific implementations, the set of bathing unit components may include bathing unit components configured for alternating between an activated state and a deactivated state in response to control signals received from the bathing unit controller. The status information conveyed by the operational information received by the communication device from the bathing unit controller may further include information conveying an activation status for at least some of the bathing unit components. In such specific implementation, the communication module may be further programmed for transmitting the water quality measurements to the remote server concurrently with one or more tags conveying the activation status information for the at least some bathing unit components when the water quality measurements were obtained. In some practical example, the remote server may include an analytics engine configured for processing the water quality measurements to derive water quality analysis information conveying at least one of: (i) water quality analysis data; or (ii) recommendations to initiate one or more actions for regulating water quality within the bathing unit system, the recommendations conveying at least one of an addition of an amount of sanitizer to the bathing unit system, an addition of a PH increaser solution, an addition of a PH reducer solution or an addition of an amount of water the bathing unit system. More specifically, the remote server may be configured for modulating an interpretation of the water quality measurements at least in part based on the activation status information at least some of the bathing unit components when the water quality measurements were obtained at least in part by processing the one or more tags.

In some specific implementations, the set of bathing unit components in the bathing unit system may further include a bathing unit cover for covering the bathing receptacle and a sensor for detecting a status corresponding to the bathing unit cover, the sensor being in communication with at least one of the bathing unit controller or the communication module, wherein the status corresponding to the bathing unit cover is one of an ON state in which the bathing unit cover is positioned on the bathing receptacle so as to cover the bathing receptacle and an OFF state in which the bathing unit cover fails to be positioned on the bathing receptacle so as to cover the bathing receptacle. In such an embodiment, the communication module may be further programmed for transmitting the water quality measurements to the remote server concurrently with a tag conveying an ON-OFF status for the bathing unit cover when the water quality measurements were obtained.

In some alternate embodiments, the status corresponding to the bathing unit cover may be one of: (i) an ON state in which the bathing unit cover is positioned on the bathing receptacle so as to fully cover the bathing receptacle; (ii) a PARTIAL ON (or PARTIAL OFF) state in which the bathing unit cover is positioned on the bathing receptacle so as to partially cover the bathing receptacle; and (iii) an OFF state in which the bathing unit cover fails to be positioned on the bathing receptacle so as to cover the bathing receptacle. In such an embodiment, the communication module may be further programmed for transmitting the water quality measurements to the remote server concurrently with a tag conveying the status for the bathing unit cover when the water quality measurements were obtained.

In some specific implementations, the set of bathing unit components in the bathing unit system may further include one or more flow sensors configured to obtain water flow measurements at one or more locations within the circulation system. The operational information provided to the communication module may further convey water flow status information corresponding to the water flow measurements obtained from at least one of the one or more flow sensors. In such an embodiment, the communication module may be further programmed for (i) selectively transmitting the water quality measurements to the remote server at least in part by processing the water flow status information conveyed by the operational information such that at least some water quality measurements obtained by the monitoring device when the water flow status information conveys a water flow through the monitoring device below a threshold flow of water are omitted from the transmissions made to the remote server; and/or (ii) transmitting the water quality measurements to the remote server concurrently with a tag conveying the water flow status information when the water quality measurements were obtained.

In accordance with another general aspect, a water quality monitoring system for a bathing unit system is provided, the bathing unit system including a bathing receptacle, a set of bathing unit components including a pump and a bathing unit controller for issuing signals for controlling operations of the set of bathing unit components, the pump being configured for alternating between an activated state and a deactivated state in response to control signals received from the bathing unit controller, wherein in the activated state the pump is configured for causing water to circulate through a circulation system of the bathing unit system. The water quality monitoring system comprises (a) a monitoring device configured to be positioned in-line with the circulation system of the bathing unit system, the monitoring device comprising at least one sensor configured to obtain water quality measurements conveying one or more characteristics of water within the circulation system; and (b) a communication module in communication with the monitoring device for receiving the water quality measurements and with the bathing unit controller, the communication module receiving operational information conveying status information for one or more bathing unit components in the set of bathing unit components, the status information including information conveying an activation status for the pump, the activation status for the pump conveying one of the activated state and the deactivated state. The communication module is configured to establish a communication channel with a remote server over a computer network and being programmed for transmitting the water quality measurements to the remote server concurrently with tags conveying the activation status for the pump when the water quality measurements were obtained.

In some specific implementations, the communication module may be further programmed for receiving water quality analysis information from the remote server and for transmitting the water quality analysis information to the bathing unit controller, the water quality analysis information conveying at least one of: (i) water quality analysis data derived at least in part by processing the water quality measurements transmitted to the remote server; or (ii) recommendations to initiate one or more actions in connection with regulating water quality within the bathing unit system derived at least in part by processing the water quality measurements transmitted to the remote server, said recommendations conveying at least one of an addition of an amount of sanitizer to the bathing unit system, an addition of a PH increaser solution, an addition of a PH reducer solution or an addition of an amount of water the bathing unit system.

In some specific implementations, the water quality monitoring system may include the remote server, the remote server including an analytics engine configured for processing the water quality measurements to derive water quality analysis information conveying at least one of: (i) water quality analysis data; or (ii) recommendations to initiate one or more actions for regulating water quality within the bathing unit system, said recommendations conveying at least one of an addition of an amount of sanitizer to the bathing unit system, an addition of a PH increaser solution, an addition of a PH reducer solution or an addition of an amount of water the bathing unit system. In practical implementations, to derive the water quality analysis information, the analytics engine may be configured for de-emphasizing a set of water quality measurements corresponding to tags conveying that the pump was in the deactivated state when water quality measurements were taken relative to other water quality measurements. In a non-limiting example, the analytics engine may be configured for discarding a set of water quality measurements corresponding to tags conveying that the pump was in the deactivated state when the water quality measurements were taken.

In accordance with another general aspect, a server is provided for monitoring a bathing unit system, the bathing unit system including a bathing receptacle, a set of bathing unit components including a pump and a network-enabled water quality monitoring system, the pump being configured for alternating between an activated state and a deactivated state in response to control signals received from the bathing unit controller, wherein in the activated state the pump is configured for causing water to circulate through a circulation system of the bathing unit system. The server comprises one or more processing units programmed for: (a) receiving, from the water quality monitoring system, water quality measurements , the water quality measurements including corresponding tags conveying activation status information for the pump of the bathing unit system when the water quality measurements were obtained, the activation status for the pump conveying one of the activated state and the deactivated state; (b) processing the water quality measurements to derive water quality analysis information conveying at least one of: (i) water quality analysis data; or (ii) recommendations to initiate one or more actions for regulating water quality within the bathing unit system, said recommendations conveying at least one of an addition of an amount of sanitizer to the bathing unit system, an addition of a PH increaser solution, an addition of a PH reducer solution or an addition of an amount of water the bathing unit system. The processing of the water quality measurements to derive the water quality analysis information includes deemphasizing a set of water quality measurements corresponding to tags conveying that the pump was in the deactivated state when water quality measurements in the set of water quality measurements were taken relative to other water quality measurements; and transmitting the water quality analysis information to at least one of: (a) the water quality monitoring system of the bathing unit system; or (b) a user device associated with a user of the bathing unit system.

In some specific implementations, processing the water quality measurements to derive the water quality analysis information may include discarding the set of water quality measurements corresponding to tags conveying that the pump was in the deactivated state when water quality measurements were taken.

In some specific implementations, the tags corresponding to the water quality measurements may further convey activation status information for one of more bathing unit components in the set of bathing unit components when the water quality measurements were obtained. In such implementation, processing the water quality measurements to derive the water quality analysis information may includes modulating interpretation of the water quality measurements at least in part based on the activation status information for the one of more bathing unit components when the water quality measurements were obtained at least in part by processing the one or more tags. The one of more bathing unit components may include, without being limited to, a sanitizer, a heater and a blower.

In some specific implementations, the bathing unit system may further include a bathing unit cover for covering the bathing receptacle and the tags corresponding to the water quality measurements may further convey a status for the bathing unit cover when the water quality measurements were obtained. In such implementation, processing the water quality measurements to derive the water quality analysis information may include modulating interpretation of the water quality measurements at least in part based the status of the bathing unit cover when the water quality measurements were obtained at least in part by processing the one or more tags.

In some specific implementations, the bathing unit system may further include one or more flow sensors configured to obtain water flow measurements at one or more locations within the circulation system of the bathing unit system and the tags corresponding to the water quality measurements may further convey water flow status information when the water quality measurements were obtained. In such implementation, processing the water quality measurements to derive the water quality analysis information may include modulating interpretation of the water quality measurements at least in part based on the water flow status information when the water quality measurements were obtained at least in part by processing the one or more tags.

Note that the expressions “at least one of A or B” and “at least one of A and B”, as used herein, are each interchangeable with the expression “A and/or B”. They refer to a list in which you may select A or B or both A and B. Similarly, “at least one of A, B, or C” and “at least one of A, B, and C”, as used herein, are each interchangeable with “A and/or B and/or C” or “A, B, and/or C”. They refer to a list in which you may select: A or B or C, or both A and B, or both A and C, or both B and C, or all of A, B and C. The same principle applies for longer lists having a same format.

All features of embodiments which are described in this disclosure and are not mutually exclusive can be combined with one another. Elements of one embodiment can be utilized in the other embodiments without further mention.

Other aspects and features of the present invention will become apparent to those ordinarily skilled in the art upon review of the following description of specific embodiments in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 is a diagram of a bathing unit system incorporating a water quality monitoring system in which a water quality monitoring device has been positioned in-line in a water circulation path in accordance with a specific example of implementation;

FIG. 2 is a functional block diagram of a communication module for a water quality monitoring system suitable for a bathing unit system of the type shown in FIG. 1 in accordance with a specific example of implementation;

FIG. 3A is a functional block diagram of a cloud-based server for a water quality monitoring system suitable for use in a bathing unit system of the type shown in FIG. 1 in accordance with a specific example of implementation;

FIG. 3B is a functional block diagram of another server for a water quality monitoring system suitable for use in a bathing unit system of the type shown in FIG. 1 in accordance with a specific example of implementation;

FIG. 4 is a flow diagram of a process implemented by a communication module of a water quality monitoring system, such as the communication module depicted in FIGS. 1 and 2, for transmitting water quality measurements to a remote server at least in part based on the activation status of the circulation pump in accordance with a specific example of implementation of the invention;

FIG. 5 is a flow diagram of a process implemented by a remoter server, such as the server depicted in FIGS. 1 and 3, for processing water quality measurements tagged with an activation status of the circulation pump to generate water quality analysis data in accordance with a specific example of implementation of the invention;

FIG. 6 is a table depicting an example of water quality measurements with corresponding tags conveying the operational status of various components of a bathing unit system when the water quality measurements were obtained in accordance with an example of implementation of the present invention; and

FIG. 7 is a block diagram of another bathing unit system equipped with a water monitoring system in accordance with an alternative example of implementation of the present invention.

It will be noted that throughout the appended drawings, like features are identified by like reference numerals.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to specific implementations and uses of embodiments of the invention in the context of bathing units. It is to be understood that the term “bathing unit”, as used for the purposes of the present description, refers to spas/swim-spas, whirlpools, hot tubs, bathtubs, therapeutic baths and swimming pools and any other type of unit having a water receptacle holding water in which a halogen has been dissolved. Moreover, it is to be appreciated that while specific embodiments of the invention have been described for using in the context of bathing units, the person skilled in the art will appreciate in view of the present description that alterative embodiments may be configured for use in an environment including a body of water other than a bathing unit in which measurement of a concentration of halogen may be of interest.

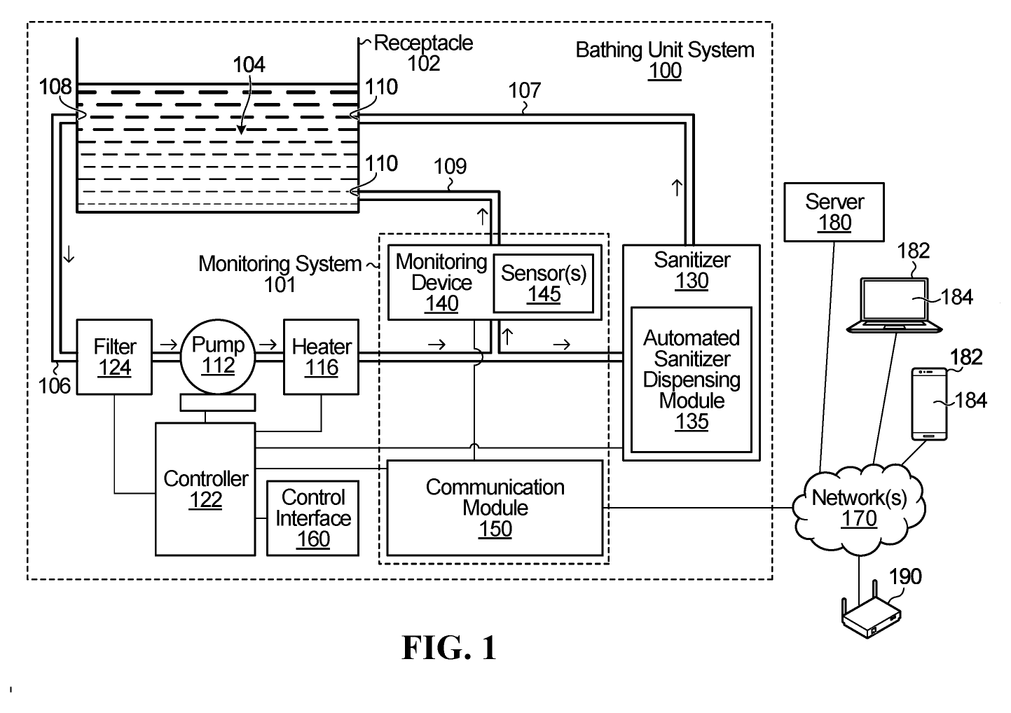

FIG. 1 illustrates a block diagram of a bathing unit system 100 incorporating a water quality monitoring system 101 in accordance with a specific example of implementation. The bathing unit system 100 includes a bathing unit receptacle 102 for holding water 104, water inlets 110 (only two are shown) which will typically be connected to respective jets, water outlets 108 (only one is shown) and a circulation system 106 including flow conduits for removing and returning water from and to the receptacle 102 through the water inlets and water outlets. The circulation system 106 depicted is shown as having a primary circulation return path 107 and a secondary circulation return path 109 for the purpose of simplicity, however, the person skilled in the art will appreciate that practical implementations of the bathing unit system 100 may include multiple flow conduits forming multiple primary and/or secondary circulation return paths interconnecting water inlets and water outlets of the receptacle 102. The bathing unit system 100 also includes a set of bathing unit components positioned within the circulation system 106. In the specific example depicted in FIG. 1, the set of bathing unit components includes a filter 124, a water pump 112 and a heater 116. It should be understood that the bathing unit 100 may include more or fewer bathing unit components that may be positioned in various suitable positions in the circulation system. The bathing unit system 100 may further include a sanitizing system 130 for sanitizing the water 104 in the receptacle 102. For example, in some embodiments, the sanitizing system 130 may comprise an automatic sanitizer dispensing module 135 configured to dispense a sanitizing agent in the water of the bathing unit system 100. For example, in one non-limiting example of implementation, the automatic sanitizer dispensing module 135 may include an electrolytic cell configured to release a free halogen in the water of the bathing unit 100.

A bathing unit controller 122 controls the settings/operation of the components of the bathing unit system 100 including the settings of the heater 116, the water pump 112, the filter 124 and/or the sanitizing system 130. The bathing unit system 100 also includes a user control interface 160 for enabling a user to provide commands for controlling the operational settings of the components in the bathing unit system 100 and optionally for conveying information related to the bathing unit system 100 to the user. The controller 122 receives electrical power from an electric power source (not shown) and controls the distribution of power supplied to the various bathing unit components on the basis of control signals originating from various sensors, program instructions and/or user commands in order to cause desired operational settings to be implemented. Some manners in which the bathing unit controller 122 may be configured and used to control the bathing unit components for the regulation of the operation of the bathing unit system 100 are generally known in the art and are not critical to the invention and as such will not be described in further detail here.

As depicted in FIG. 1, a water quality monitoring system 101 may be used in connection with the bathing unit system 100. More specifically, the water quality monitoring system 101 is configured to obtain water quality measurements conveying one or more characteristics of water within the circulation system 106 and selectively transmit the water quality measurements to a remote server 180 at least in part based on the activation status of the pump 112 when the water quality measurements were obtained and/or transmit the water quality measurements to the remote server 180 with a tag conveying the activation status of the pump when the water quality measurements were obtained. In particular, in the specific example implementation shown in FIG. 1, the water quality monitoring system 101 includes a monitoring device 140 and a communication module 150.

The monitoring device 140 is configured to be positioned in-line with the circulation system 106 of the bathing unit system. More specifically, in the example implementation shown in FIG. 1, the monitoring device 140 is positioned in-line with the secondary return circulation path 109. As shown in FIG. 1, the monitoring device 140 includes at least one sensor 145 configured to obtain water quality measurements conveying one or more characteristics of water within the circulation system 106. For example, in some embodiments, the sensor(s) 145 may include a pH sensor, an oxidation-reduction potential (ORP) sensor, a turbidity sensor, an alkalinity sensor and/or a temperature sensor.

In the example implementation shown in FIG. 1, the communication module 150 is in communication with the monitoring device 140 for receiving the water quality measurements and with the bathing unit controller 122 for receiving operational information conveying status information corresponding to control signals for controlling operation of one or more of the bathing unit components in the set of bathing unit components, including at least an activation status for the pump 112.

In the example of implementation shown in FIG. 1, the communication module 150 is in communication with the remote server 180 via communication network(s) 170, which can include multiple different types of communication networks, such as a wired or wireless local area network (e.g., a wi-fi network) and/or a public data network such as the internet. The communication module 150 is connected to the network(s) 170, enabling the communication module 150 to communicate with one or more remote devices and/or to access one or more remote services through the network(s) 170. For example, in one non-limiting example of implementation, the communication network(s) 170 includes a (home) Wi-Fi network established by a router 552. More specifically, in this example of implementation, the communication module 150 may communicate with a plurality of remote user devices 182, including for example a smart phone and a laptop, and the server 180 through the Wi-Fi network established by the router 552.

In the specific example implementation shown in FIG. 1, the communication module 150 is programmed to: i) selectively transmit the water quality measurements to the remote server 180 at least in part by processing the status information such that at least some water quality measurements obtained by the monitoring device when the pump is inactive are selectively omitted from being transmitted to the remote server 180; and/or ii) transmit the water quality measurements to the remote server with a tag conveying the activation status of the pump when the water quality measurements were obtained so that each measurement corresponds to an indication of whether the measurement was taken when the pump was active or inactive. In this way, the server 180 is able to derive water quality analysis information for the bathing unit system 100 based on water quality measurements that were obtained while the pump 112 was active, while water quality measurements obtained when the pump is inactive are selectively omitted, or de-emphasized relative to the measurements obtained when the pump was active, to derive the water quality analysis information. For example, in some embodiments, the server 180 is configured to receive water quality measurements from the communication module 150 that include a tag conveying the activation status of the pump 112 when the water quality measurements were obtained. In such embodiments, the server 180 may be configured to derive water quality analysis information for the particular bathing unit system at least in part by processing the water quality measurements, wherein processing the water quality measurements for the particular bathing unit system includes emphasizing water quality measurements taken when the pump 112 was active relative to water quality measurements taken when the pump was inactive, for example by attributing a high weighting to measurements obtained when the pump was active than when the pump was inactive. In a specific example, processing the water quality measurements for the particular bathing unit system may include selectively discarding the water quality measurements at least in part based on the included tag such that water quality measurements obtained when the pump is inactive are selectively omitted from being used to derive the water quality analysis information for the bathing unit system 100, which amounts to attributing a “0” weight to measurements obtained when the tag conveys that the measurements were taken when the pump was inactive. In some embodiments, the water quality analysis information includes: i) water quality analysis data for the bathing unit system 100, such as the pH level, ORP level, turbidity level, and/or temperature of the water within the bathing unit system 100; and/or a recommendation to initiate one or more actions in connection with regulating water quality within the bathing unit system 100. In specific practical implementations, the recommendation may convey an addition of an amount of sanitizer to the bathing unit system, an addition of a PH increaser solution, an addition of a PH reducer solution or an addition of an amount of water the bathing unit system in order to achieve a desired water quality level.

In some embodiments, the server 180 is configured to transmit the water quality analysis information for the bathing unit system 100 to the communication module 150 of the water quality monitoring system 101 and/or to one or more of the remote user device 182 associated with the bathing unit system 100. For example, the water quality analysis information may be configured to cause a notification conveying the water quality analysis data and/or recommendation(s) to initiate action(s) to be displayed to a user on a display interface 184 of one or more of the remote user devices 182 and/or on a display interface of the user control interface 160 of the bathing unit system 100.

In some embodiments, the remote user devices 182 may run a client application for remotely monitoring and/or controlling the bathing unit system 100 and may be configured to generate and display a graphic user interface on the display interface 184 of the remote device in order to facilitate that functionality. For example, in some embodiments, the remote user devices 182 may be configured to display a graphic user interface configured to convey characteristics of the bathing unit system 100, and notifications indicative of water quality in the bathing unit system 100, such as chemical levels and/or recommended user actions based on the identified chemical levels. For example, in some implementations the remote devices 182 may run a client application that facilitates the selection of monitoring parameters to configure the water quality monitoring system 101 to monitor and transmit measurements at defined intervals (e.g., daily or hourly) or, in some instances, on a continual basis.

In some embodiments, the water quality analysis information received from the remote server 180 may be used by the controller 122 to automatically regulate operation of one or more of the bathing unit components to automatically regulate water quality within the bathing unit system 100. For example, in one example of implementation, the water quality analysis information from the remote server 180 may be used for automatic regulation of the automated sanitizer dispensing module 135, the heater 116 and/or the pump 112.

### Practical Examples of Implementation – Communication Module 150

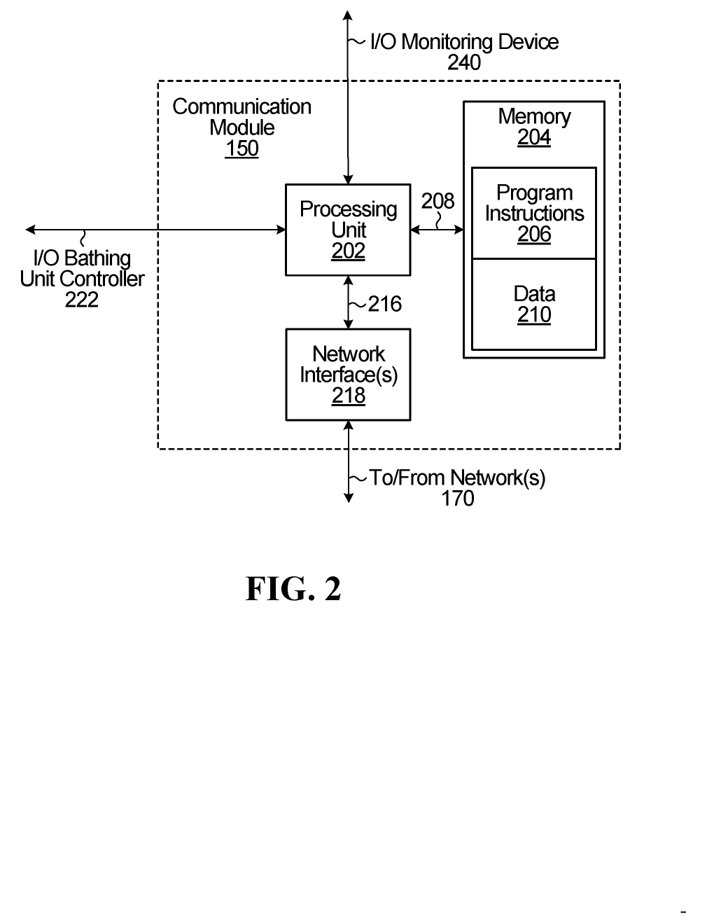

FIG. 2 is a functional block diagram of a specific example of implementation of the communication module 150 for the water quality monitoring system 101 suitable for the bathing unit system 100 shown in FIG. 1.

In the specific example of implementation shown in FIG. 2, the communication module 150 includes a processing unit 202, a memory 204 and network interface(s) 218. The processing unit 202 and the memory 208 are connected by a communication bus 208. The processing unit 202 and the network interface(s) 218 are connected by a communication bus 216. The memory 204 includes program instructions 206 and data 210. The processing unit 202 is adapted to process the data 210 and the program instructions 206 in order to implement the functionality of the communication module 150 described in the specification and depicted in the drawings.

The communication module 150 comprises one or more I/O interfaces for receiving and/or sending data elements to external devices. In particular, the communication module comprises an I/O interface 222 for exchanging signals with the controller 122 (not shown in the figures) of the bathing unit system 100 (shown in FIG. 1) and an I/O interface 1240 for exchanging signals with the monitoring device 140 and an I/O interface 1216 for exchanging signals with the user control interface 118 (and/or auxiliary control interface 119).

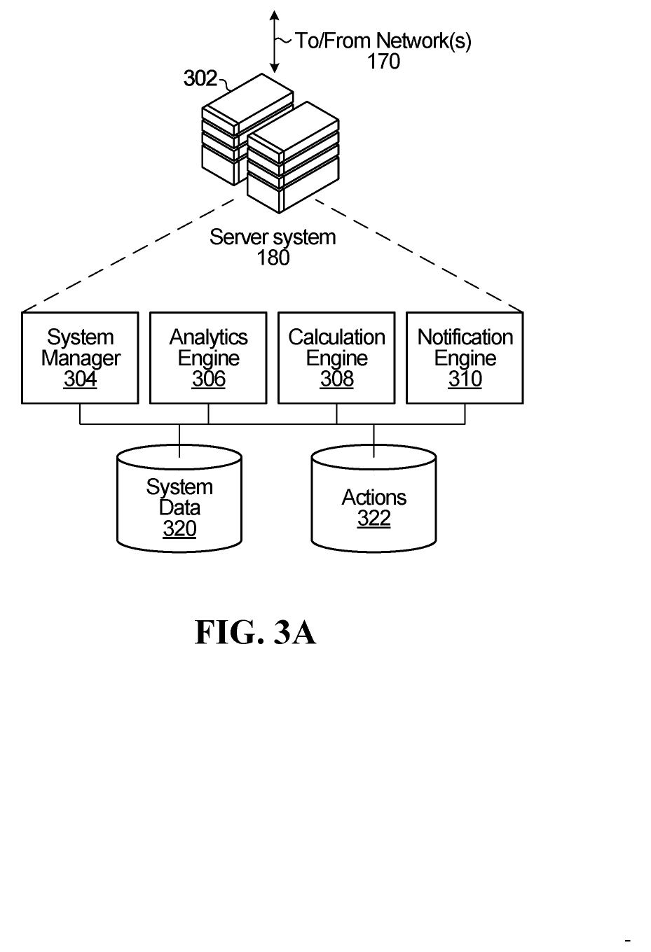

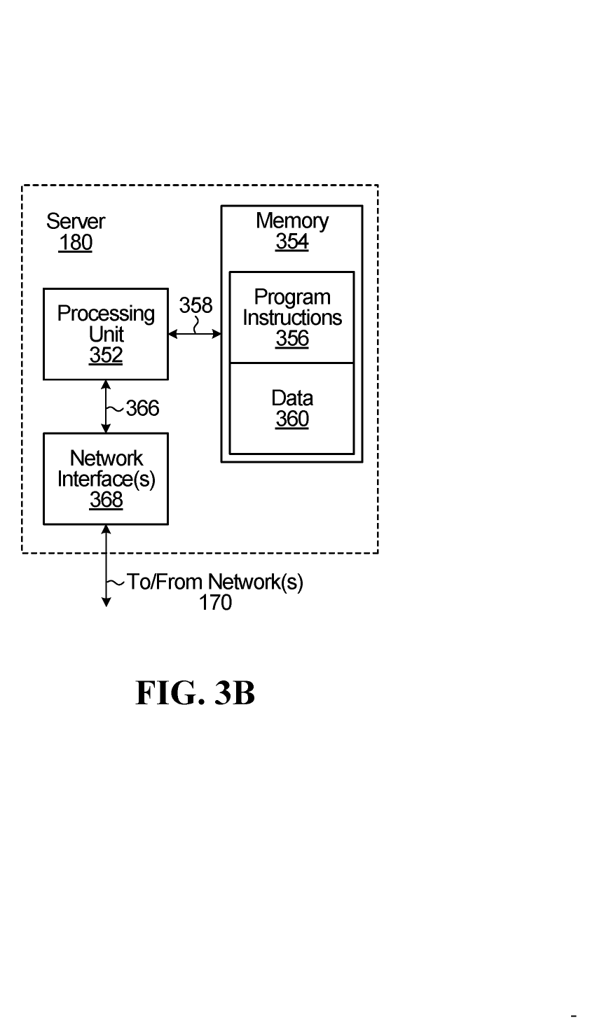

The network interface(s) 218 are configured for wired and/or wireless communication with remote devices and/or services, such as the remote user devices 182 and the remote server 180, via communication network(s) 170 to allow for remote and/or web-based control, discussed in greater detail in connection with FIGS. 3A and 3B. In some embodiments, the network interface(s) 218 may include wired links (e.g., Ethernet cable) and/or wireless links (e.g., one or more antennas) for intra-network and/or inter-network communications. The network interface(s) 218 may be connected to one or more antennas of the communication module (not shown), which are configured to facilitate wireless communication that may be implemented by the network interface(s) 218.

### Practical Examples of Implementation – Server 180

FIG. 3A is a functional block diagram of a specific example of implementation of the server 180 for remote processing of water quality measurements obtained by the water quality monitoring system 101 of the bathing unit system 100 shown in FIG. 1. In particular, in the specific example of implementation shown in FIG. 3A, the functionality of the server 180 described above is implemented with a cloud-based server system 180 that comprises software components and databases that can be deployed in one or more datacenters 302 located in one or more geographical locations. In this specific example of implementations, the server system 180 software components comprise a system manager 304, an analytics engine 306, a calculation engine 308 and a notification engine 310. The server system 180 databases comprise a system data database 320 and an actions database 322. The databases 320 and 322 can reside in one or more physical storage systems.

Referring again to FIG. 1, the water quality measurements from the inline water quality monitoring system 101 may be transmitted via the communication network(s) 170 to the system manager 304 of the server system 180. The system manager 304 is configured for coordinating operations of the various components in the service system 180 including the analytics engine 306, calculation engine 308 and notification engine 310. In addition, the system manager 304 is configured to store the measurement data received from the communication module 150 in the system database 320 for later retrieval. The server system 180 can determine water quality analysis information (e.g., water quality analysis data and/or recommendations/notifications to be displayed to a user) by calling upon the analytics engine 306to process the water quality measurement data. In some embodiments, the server system 180 may transmit the water quality analysis information to the remote user devices 182 for display thereon (e.g., via a client applications running on the user device 182 configured to to cause a notification conveying the water quality analysis data and/or recommendation(s) to be displayed to a user on the display interface 184 of the user device) and/or to the communication module 150 for display on the control interface 160 of the bathing unit system 100.

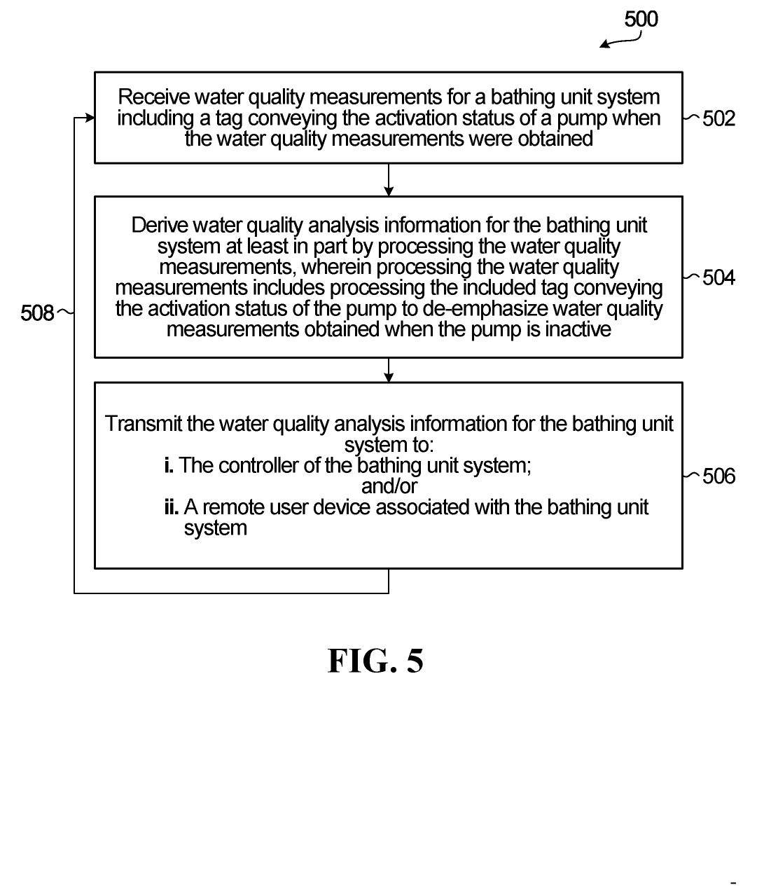

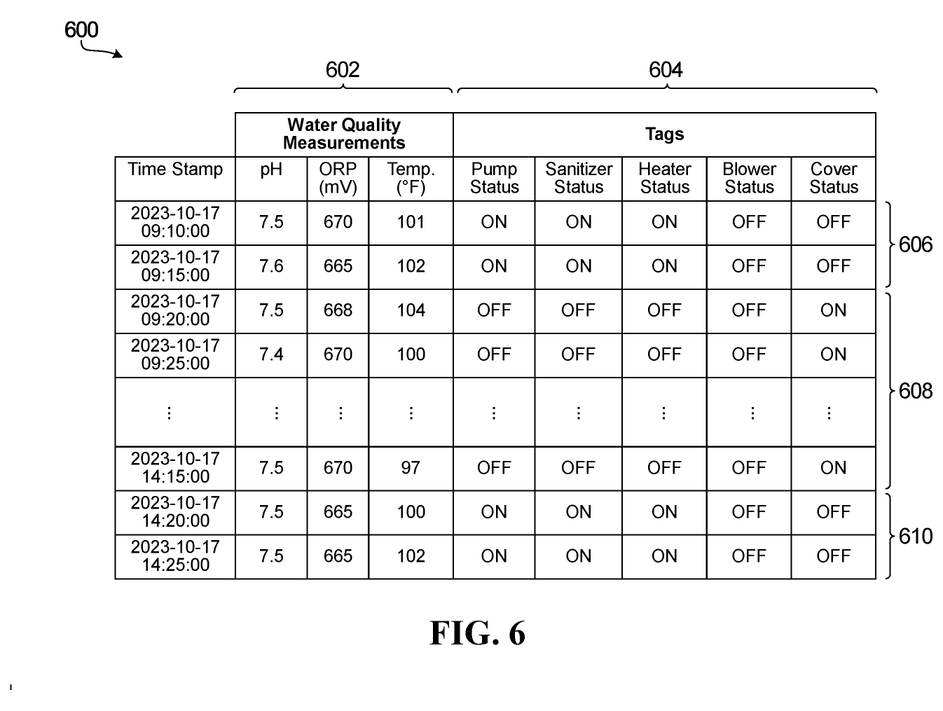

As described earlier, in some embodiments the communication module 150 selectively transmits water quality measurements to the remote server 180 at least in part based on the activation status of the pump 112 when the measurements were obtained. In such embodiments, water quality measurements obtained when the pump 112 is inactive may not be transmitted to the remote server by the communication module 150, and therefore the analytics engine 306 may be configured to assume that water quality measurements it receives for the bathing unit system 100 were obtained when the pump was active. On the other hand, in some alternate embodiments the communication module 150 may be configured to transmit water quality measurements for the bathing unit system 100 with a tag conveying the activation status of the pump 112 when the measurements were obtained. The pump 112 is configured for alternating between an activated state and a deactivated state in response to control signals received from the bathing unit controller 122, wherein in the activated state the pump is configured for causing water to circulate through a circulation system of the bathing unit system, In a specific implementation, the activation status for the pump conveys one of the activated state and the deactivated state. In such embodiments, the analytics engine 306 can determine whether the pump 112 was active when certain water quality measurements were obtained by processing the tag associated with those measurements. The features and operations of the analytics engine in such embodiments will be discussed in further detail below in connection with FIGS. 5 and 6.

The analytics engine 306 is configured for processing the water quality measurements received from the communication module 150 to derive water quality analysis information conveying water quality analysis data. As described above, the analytics engine 306 is configured for modulating the interpretation of the water quality measurements at least in part based on the activation status of the pump for example by processing information in the tags, when available. In implementation where the communication module 150 omits to transmit water quality measurements taken when the pump was inactive, all water quality measurements received at the server are assumed to have been taken when the pump was active. In a specific implementation, the water quality analysis information may convey whether the water quality measurements fall within desirable quality ranges (for example withing a desirable pH range and/or a desirable ORP level range) and/or how much outside such desirable quality ranges the measurements are. Any suitable methods and algorithms may be used to derive the water quality analysis information and examples of such methods will become apparent to the person skilled in the art and as such will not be described in further detail here.

In addition, the analytics engine 306 may optionally be configured for using the derived water quality analysis data to derive recommendations to initiate one or more actions for regulating water quality within the bathing unit system so that the water quality is altered to fall within (or closer to) the desirable quality ranges (for example withing or closer to a desirable pH range and/or a desirable ORP level range). In the embodiment depicted, the recommendations may be derived by analytics engine 306 by calling upon functionality implemented by the calculation engine 308, which will be described below. The recommendations may convey, for example, an addition of an amount of sanitizer to the bathing unit system, an addition of a PH increaser solution, an addition of a PH reducer solution or an addition of an amount of water the bathing unit system.

In a specific implementation, the calculation engine 308 is a software component that is configured to calculate an amount of a particular chemical (or of an amount of water) to be added to a bathing unit system at least in part by processing the water quality analysis information derived by the analytic engine 306in combination with other information data elements, such as, for example but without being limited to, volume information conveying a volume of water in the receptacle 102 of the bathing unit system. In addition, in some embodiments, the calculation engine 308 may determine a user action and/or an automated action corresponding to the calculated amount of the particular chemical (or water) to be added to the bathing unit system 100. It will be appreciated that any suitable methods and algorithms may be used to derive the recommendations and examples of such methods will become apparent to the person skilled in the art and as such will not be described in further detail here.

The system manager 304 can transmit a notification by calling upon the notification engine 310, wherein the notification includes the user action and/or automated action to the remote user devices 182 to be displayed on the display interface 184 of the user device and/or to the communication module 150 to be communicated to the controller 122 to cause the notification to be displayed on a display interface of the control interface 160 and/or to be used as a basis for the automatic regulation of one or more of the bathing unit components. In such an implementation, the notification engine 310 including the required communication protocols and information to be able to issue notifications to devices external to the server system 180.

In some embodiments, the calculation engine 308 can further be configured to measure or predict an impact on the bathing unit system (e.g., a change in a measured characteristic of the water in the bathing unit system) of the amount of a particular chemical added to a given volume of water and measured characteristics of the water by the inline water quality monitoring system 101 after the amount of the particular chemical is applied to the water in the bathing unit system.

In some embodiments, the server system 180 can optionally be programmed for identifying potential errors/problems in the bathing unit system 100 by processing the water quality measurement data provided by the inline water quality monitoring system 101 and stored in the system data database 130. In addition, in response to the identification of a specific potential error/problem, the server system 180 may be programmed to generate and transmit a notification to a device associated with a user (or owner) of the bathing unit system 100, for example by sending a notification, via the notification engine 310, to the remote user devices 182 and/or the communication module 150 of the water quality monitoring system 101. In some implementations, the notification may include information conveying the potential error/problem and/or a user action and/or an automated action to alleviate or correct the identified potential error/problem. For example, the user action and/or automated action may convey a recommendation to add a specific quantity of water to the bathing unit system 100, or to add water up to a predetermined water level, in response to the server system 180 identifying that the bathing unit system 100 has lost water due to evaporation or leakage (e.g., a crack on a side or bottom of the pool or spa) or in response to water quality parameters indicating an insufficient amount of water. In some embodiments, the server system 180 can be configured for identifying a potential leakage problem for a particular bathing unit system based on measurement data received from inline water quality monitoring systems 101 for a plurality of bathing unit systems including the particular bathing unit system and at least one ore more additional bathing unit system located in a geographical proximity to the particular bathing unit system (e.g., within a predetermined radius from the particular bathing unit system, such as within five miles of particular bathing unit system).

In some embodiments, the server system 180 may also store records of a service network of certified pool or spa technicians to facilitate delegating pool or spa maintenance tasks.

In the example depicted in FIG. 3A, the server system 180 is configured to store in the system data database 320 and in the actions data database 322 information and actions associated with the water quality monitoring systems for multiple bathing unit systems, inclusive of the water quality monitoring system 101 for the bathing unit system 100. For example, in some embodiments, the server system 180 may store, for each water quality monitoring system associated with a respective bathing unit system, location information, action status information, service request information, user actions to be performed and action history information.

FIG. 3B is a functional block diagram of another specific example of implementation of the server 180 for remote processing of water quality measurements obtained by the water quality monitoring system 101 of the bathing unit system 100 shown in FIG. 1. In particular, in the specific example of implementation shown in FIG. 3B, the functionality described above is implemented with by a server 180 that comprises a processing unit 352, a memory 354 and network interface(s) 368. The processing unit 352 and the memory 354 are connected by a communication bus 358. The processing unit 352 and the network interface(s) 368 are connected by a communication bus 366. The memory 354 includes program instructions 356 and data 360. The processing unit 352 is adapted to process the data 360 and the program instructions 356 in order to implement the functionality of the server 180 described in the specification and depicted in the drawings. For example, in some implementations, the program instructions 356 may include instructions that when executed by the processing unit 352 implement the functionality of the system manager 304, analytics engine 306, calculation engine 308 and/or notification engine 310 of the server system 180 shown in FIG. 3A. Similarly, in such embodiments the data 360 stored in the memory 354 may include the system database 320 and the actions database 322.

The network interface(s) 368 are configured for wired and/or wireless communication with remote devices and/or services, such as the remote user devices 182 and the water quality monitoring system 101 of the bathing unit system 100, via communication network(s) 170 to facilitate remote and/or web-based control as described herein. In some embodiments, the network interface(s) 368 may include wired links (e.g., Ethernet cable) and/or wireless links (e.g., one or more antennas) for intra-network and/or inter-network communications. The network interface(s) 368 may be connected to one or more antennas of the server 180 (not shown), which are configured to facilitate wireless communication that may be implemented by the network interface(s) 368.

### Methods – Communication Module 150

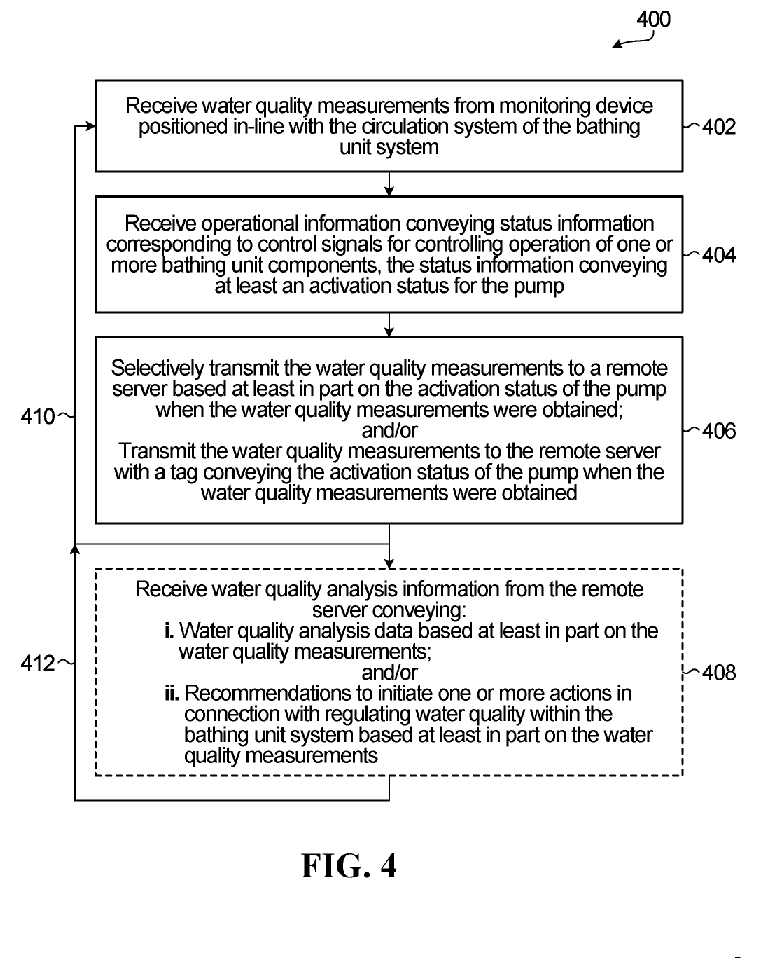

FIG. 4 is a flow diagram of a process 400 implemented by a communication module of a water quality monitoring system, such as the communication module 150 of the water quality monitoring system 101 shown in FIG. 1, for transmitting water quality measurements for a bathing unit system to a remote server at least in part based on an activation status of a circulation pump of the bathing unit system in accordance with a specific example of implementation of the invention. More specifically, in this example of implementation, the process 400 is implemented by a communication module of a water quality monitoring system for a bathing unit system that includes a bathing receptacle, a set of bathing unit components including at least one pump for circulating water through a circulation system and a bathing unit controller for issuing signals for controlling operations of the set of bathing unit components.

The process 400 begins at step 402, in which the communication module 150 receives water quality measurements from a monitoring device 140 positioned in-line with the circulation system of the bathing unit system, wherein the water quality measurements convey one or more characteristics of water within the circulation system of the bathing unit system. For example, the monitoring device may include one or more sensors, such as a pH sensor, an ORP sensor, a turbidity sensor, an alkalinity sensor and/or a temperature sensor, configured to be positioned in-line with a circulation flow path of the circulation system to obtain the water quality measurements.

At step 404, the communication module 150 receives operational information from the bathing unit controller conveying at least status information for one or more bathing unit components in the set of bathing unit components. In this specific example of implementation, the status information conveys at least an activation status for the pump 112 (shown in FIG. 1) indicating whether the pump 112 was active or inactive when the water quality measurements were obtained. For example, in some embodiments the water quality measurements and the operational information, including at least the status information indicating the activation status of the pump, may be timestamped to facilitate determination of the activation status of the pump when the water quality measurements were obtained.

At step 406, the communication module 150: i) selectively transmits the water quality measurements to a remote server, such as the remote server 180 shown in FIGS. 1, 3A and 3B, at least in part by processing the status information for one or more bathing unit components in the set of bathing unit components, including at least the activation status for the pump 112 such that at least some water quality measurements obtained by the monitoring device when the pump 112 is inactive are omitted from being transmitted to the remote server; and/or ii) transmits the water quality measurements to the remote server with a tag conveying the activation status of the pump when the water quality measurements were obtained.

As shown by path 410, in some embodiments after step 406 the process 400 returns to step 402 in which further water quality measurements are received from the monitoring device. In addition or instead, at step 408 the communication module may receive water quality analysis information from the remote server 180. For example, as shown in FIG. 4, the water quality analysis information may convey: i) water quality analysis data based at least in part on the water quality measurements transmitted to the remote server; and/or ii) recommendations to initiate one or more actions in connection with regulating water quality within the bathing unit system 100 based at least in part on the water quality measurements transmitted to the remote server 180. As shown by path 412, in some embodiments, after step 408 the process 400 returns to step 402 in which further water quality measurements are received from the monitoring device 140.

In some embodiments, the communication module may also selectively transmit the water quality measurements to the bathing unit controller 122 at least in part based on the activation status of the pump and/or transmit the water quality measurements to the bathing unit controller 122 with a tag conveying the activation status of the pump when the water quality measurements were obtained. In such embodiments, the bathing unit controller 122 may be configured for processing the water quality measurements and present information derived therefrom on the user control interface 122 of the bathing unit system 100.

In some embodiments, the status information for one or more bathing unit components in the set of bathing unit components conveyed by the operational information received at the communication module 150 from the bathing unit controller 122 may convey the operational status of components in the set of bathing unit components other that the pump 112. In such embodiments, the selective transmission of the water quality measurements by the communication module 150 to the remote server 180 may be further condition by processing the operational status of one or more of the components in the set of bathing unit components other than the pump and/or the water quality measurements transmitted to the remote server 180 may include one or more tags conveying the operational status of one or more of the other components in the set of bathing unit components when the water quality measurements were obtained.

For example, in some embodiments, the set of bathing unit components includes a sanitizer, such as sanitizer 130, in fluid communication with the circulation system for adding a sanitizing agent to the water within the circulation system. In some embodiments, the sanitizer 130 may be configured for alternating between an activated state and a deactivated state in response to control signals received from the bathing unit controller 122, wherein in the activated state the sanitizer 130 is configured for adding a sanitizing agent to the water circulating through the circulation system and wherein in the deactivated state the sanitizer 130 omits to add the sanitizing agent. The activation status for the sanitizer 130 may therefore convey one of the activated state and the deactivated state for the sanitizer. In some such embodiments, the communication module may: i) selectively transmit the water quality measurements to the remote server 180 at least in part by processing the status information such that at least some water quality measurements obtained by the monitoring device 140 when the sanitizer is in the activated state are omitted from transmissions made to the remote server 180. In addition or instead, the water quality measurements transmitted to the remote server 180 may be sent concurrently with a tag conveying the activation status for the sanitizer 130 when the water quality measurements were obtained.

Similar operations may also or instead be performed on the basis of the operational status of other bathing unit components that may be controlled by the bathing unit controller 122, such as a heater 116, an air blower (not shown in the Figures). Similar operations may also or instead be performed on the basis of the operational status of other, such as a bathing unit cover (not shown in the Figures), that may not be controlled by the bathing unit controller 122 but may nonetheless have operational statuses that can be monitored via sensors and communicated to the bathing unit controller the communication module 150 either directly or via the bathing unit controller 122.

To illustrate a specific example, the bathing unit system 100 may include a bathing unit cover (not shown in the Figures) for covering the bathing receptacle 104 and a sensor (not shown in the Figures) for detecting a status corresponding to the bathing unit cover. The sensor may be any suitable sensor (e.g., a light sensor or some other form of switch that is triggered when the cover is ON or OFF and/or via user provided input) and is in communication with at least one of the bathing unit controller 122 or the communication module 150. Optionally, the sensor may be further configured for detecting when the bathing unit is partially on (partially off) in addition to detecting when it is fully ON or fully OFF. The status corresponding to the bathing unit cover may be one of an ON state in which the bathing unit cover is suitably positioned on the bathing receptacle 104 so as to cover the bathing receptacle and an OFF state in which the bathing unit cover fails to be suitably positioned on the bathing receptacle 104 so as to cover the bathing receptacle. The operational information for the bathing unit cover conveys an ON-OFF status for the bathing unit cover. In some alternate embodiments, the status corresponding to the bathing unit cover may be one of: (i) an ON state in which the bathing unit cover is positioned on the bathing receptacle so as to fully cover the bathing receptacle; (ii) a PARTIAL ON (or PARTIAL OFF) state in which the bathing unit cover is positioned on the bathing receptacle so as to partially cover the bathing receptacle; and (iii) an OFF state in which the bathing unit cover fails to be positioned on the bathing receptacle so as to cover the bathing receptacle. In such an embodiment, the operational information for the bathing unit cover conveys an ON, PARTIALLY-ON (or PARTIALLY OFF), or OFF status for the bathing unit cover.

As described above, the communication module 150 may be programmed to: i) selectively transmits the water quality measurements to the remote server, by processing the status information for the bathing unit cover such that at least some water quality measurements obtained by the monitoring device when the bathing unit cover is in an ON state (or PARTIALLY ON or PARTIALLY OFF state) are omitted from being transmitted to the remote server or are transmitted to the remote server at a reduced frequency relative to when the bathing unit cover is in an OFF state; and/or ii) transmits the water quality measurements to the remote server 180 with a tag conveying the state of the bathing unit cover when the water quality measurements were obtained.

As another example. the set of bathing unit components includes a heater, such as heater 116, in fluid communication with the circulation system for heating water within the circulation system, and the status information further conveys at least an activation status for the heater 116. In particular, the heater 116 is configured for alternating between an activated state and a deactivated state in response to control signals received from the bathing unit controller 122, wherein in the activated state the heater 116 is configured for heating water in the circulation system and wherein in the deactivated state the heater does not heat water in the circulation system. In a specific example, the activation status for the heater 116 conveys one of the activated state and the deactivated state. In some such embodiments, the communication module 150 may be programmed to: i) selectively transmits the water quality measurements to the remote server by processing the status information for the heater 116 such that at least some water quality measurements obtained by the monitoring device140 when the heater 116 is in the deactivated state are omitted from being transmitted to the remote server or are transmitted to the remote server at a reduced frequency relative to when the heater is in an deactivated state; and/or ii) transmits the water quality measurements to the remote server 180 with a tag conveying the activation status for the heater 116 when the water quality measurements were obtained.

As another example. the set of bathing unit components includes a blower(not shown in the figures) in fluid communication with the circulation system for heating water within the circulation system, and the status information further conveys at least an activation status for the blower. In some such embodiments, the communication module 150 may be programmed to: i) selectively transmits the water quality measurements to the remote server by processing the status information for the blower such that at least some water quality measurements obtained by the monitoring device140 when the blower is in the deactivated state are omitted from being transmitted to the remote server or are transmitted to the remote server at a reduced frequency relative to when the blower is in an deactivated state; and/or ii) transmits the water quality measurements to the remote server 180 with a tag conveying the activation status for the blower when the water quality measurements were obtained.

FIG. 6 shows a table 600 depicting an example of water quality measurements 604 that include a set of tags 606 conveying the operational status of various components of a bathing unit system in accordance with an example of implementation of the present invention. In the specific example of implementation shown in FIG. 6, the water quality measurements 602 as associated with respective tags 604 and are also timestamped. As can be seen from FIG. 6, the first two samples of water quality measurements indicated at 606 were obtained when the pump 112 was active. The subsequent samples of the water quality measurements indicated at 608 were obtained when the pump was inactive, while the later samples indicated at 610 were taken when the pump 112 was active. As such, in some embodiments, the samples of the water quality measurements indicated at 606 and 610 may be transmitted to the remote server 180 for processing, while the sample of the water quality measurements indicated at 608 may be omitted from being transmitted to the remote server 180. Alternatively, all of the samples of the water quality measurements indicated at 606, 608 and 610 may be transmitted to the remote server 180 concurrently with the pump activation status tag to advise the remote server 180 of the activation status of the pump 112 when the water quality measurements were obtained, thereby allowing the remote server to take the activation status of the pump 112 when processing the water quality measurements 602.

In some embodiments, the bathing unit system 100 may include one or more flow sensors in fluid communication with the circulation system and configured to obtain water flow measurement information for at one or more locations within the circulation system. The one or more flow sensors may be in communication with the communication module 150 either directly or via the controller 122. In some embodiments, the operational information provided to the communication module 150 by the bathing unit controller 122 may further convey water flow status information corresponding to the water flow measurements obtained from at least one of the one or more flow sensors, the water flow status information conveying water flow status for water flow through the monitoring device 140. In such embodiments, the communication module 150 may be programmed to: i) selectively transmit the water quality measurements to the remote server 180 at least in part by processing the water flow status information conveyed by the operational information such that at least some water quality measurements obtained by the monitoring device when the water flow status for water flow through the monitoring device is below a threshold are omitted from being transmitted to the remote server; and/or ii) transmit the water quality measurements to the remote server with a tag conveying the water flow status through the monitoring device when the water quality measurements were obtained.

In some embodiments, the water flow status information and the pump activation status may be used independently from one another, or in combination, to identify potential problems in the circulation system for example that there is something wrong with the pump 112 and/or there is a flow restriction somewhere in the circulation system resulting in insufficient water flow for the purpose of obtaining valid water quality measurements.

### Methods – Server 180

FIG. 5 is a flow diagram of a process 500 implemented by a remoter server, such as the server 180 depicted in FIGS. 1, 3A and 3B, for processing water quality measurements tagged with an activation status of the circulation pump 112 to generate water quality analysis data in accordance with a specific example of implementation of the invention.

The process 500 begins at step 502, in which the server 180 receives, from the water quality monitoring system 101 of a bathing unit system 100, water quality measurements obtained from at least one sensor 145 positioned in-line with the circulation system of the bathing unit system 100 and conveying one or more characteristics of water within the circulation system of the bathing unit system. In this specific example, the water quality measurements include a tag conveying an activation status of the pump 112 of the bathing unit system 100 when the water quality measurements were obtained.

At step 504, the server 180 is programmed to derive water quality analysis information for the bathing unit system at least in part by processing the water quality measurements, wherein processing the water quality measurements for the bathing unit system includes emphasizing water quality measurements corresponding to tags conveying that the pump was in the activated state relative to other water quality measurements. In a specific example, the server 180 is programmed to discard a set of water quality measurements corresponding to tags conveying that the pump was in the deactivated state when water quality measurements in said set of water quality measurements were taken so that thee measurements re omitted from being used to derive the water quality analysis information.

For example, referring again to the table 600 shown in FIG. 6, it is noted that, in some embodiments, the samples of the water quality measurements indicated at 608 may be de-emphasized relative to water quality measurements indicated at 606 and 610, or simply omitted, wherein deriving the water quality analysis information at step 504 of the process 500 shown in FIG. 5 based on the pump activation status flag indicating that the pump was inactive when those water quality measurements were obtained.

In some embodiments, the water quality analysis information derived by the server at step 504 conveys: i) water quality analysis data for the bathing unit system; and/or ii) a recommendation to initiate one or more actions in connection with regulating water quality within the bathing unit system. Any suitable methods and algorithms may be used to derive the water quality analysis information and examples of such methods will become apparent to the person skilled in the art and as such will not be described in further detail here.

At step 506, the server 180 transmits the derived water quality analysis information for the bathing unit system to: i) the controller 122 of the bathing unit system 100; and/or ii) a remote user device associated with the bathing unit system, such as one of the user devices 182 associated with the bathing unit system 100 shown in FIG. 1.

As shown at by path 508, in some embodiments after step 506, the process 500 returns to step 502 in which further water quality measurements obtained by the water quality monitoring system 140 are received.

In some embodiments, the water quality measurements for the bathing unit system 100 may include tags conveying the operational status of components of the bathing unit system other than that of the pump 112. In such embodiments, when deriving the water quality analysis information for the bathing unit system 100, the server 180 may be programmed to modulate the results at least in part by processing the operational status of one or more of the components of the bathing unit system 100 when the water quality measurements for the bathing unit system were obtained (as indicated by the corresponding tags).

For example, in some embodiments, the set of bathing unit components includes a sanitizer in fluid communication with the circulation system for adding a sanitizing agent to the water within the circulation system, and the water quality measurements for the bathing unit system further include a tag conveying an activation status for the sanitizer when the water quality measurements were obtained. In such embodiments, deriving the water quality analysis information for the bathing unit system at 504 may include deriving the water quality analysis information at least in part by processing the included tag conveying the activation status for the sanitizer when the water quality measurements were obtained to modulate the derived water quality analysis information based on such tag. For example, in some embodiments, water quality measurements obtained when the sanitizer was active may be omitted from being used to derive the water quality analysis information, may be de-emphasized related to water quality measurements obtained when the sanitizer was not active or may otherwise be weighted and/or handled differently to account for the recent addition of sanitizer in the circulation system. The specific calculations performed are beyond the scope of the present disclosure and as such will not be described in further detail here.

Similar operations may also or instead be performed on the basis of the operational status of other bathing unit components as conveyed by the tags corresponding to the water quality measurements.

For example, in some embodiments the set of bathing unit components includes a heater, such as heater 116, in fluid communication with the circulation system for heating water within the circulation system, and the water quality measurements for the bathing unit system further are provided concurrently with a tag conveying an activation status of the heater when the water quality measurements were obtained. In such embodiments, deriving the water quality analysis information for the bathing unit system at 504 may include deriving the water quality analysis information at least in part by processing the tag conveying the activation status of the heater when the water quality measurements were obtained to modulate the derived water quality analysis information based on such tag. For example, in some embodiments, water quality measurements obtained when the heater is active may be assigned a different weighting (for example a lower or higher weighting), or be omitted entirely, in calculations used to derive the water quality analysis information.

Similarly, the set of bathing unit components may include a blower in fluid communication with the circulation system for introducing air into the water in the bathing unit receptacle, and the water quality measurements may be provided concurrently with a tag conveying an activation status of the blower when the water quality measurements were obtained. In such embodiments, deriving the water quality analysis information for the bathing unit system at step 504 may include deriving the water quality analysis information at least in part by processing the included tag conveying the activation status of the blower of the bathing unit system when the water quality measurements were obtained to modulate the derived water quality analysis information based on such tag. For example, in some embodiments, water quality measurements obtained when the blower is active may be assigned a different weighting (for example a lower or higher weighting), or be omitted entirely, in calculations used to derive the water quality analysis information.

Similarly, the water quality measurements for the bathing unit system may be provided concurrently with a tag conveying a status for a bathing unit cover when the water quality measurements were obtained. In such embodiments, deriving the water quality analysis information for the bathing unit system at 504 may include processing the included tag conveying the status of the bathing unit cover when the water quality measurements were obtained to modulate the derived water quality analysis information based on such tag. For example, in some embodiments, water quality measurements obtained when the cover is ON may be assigned a different weighting (for example a lower or higher weighting), or be omitted entirely, in calculations used to derive the water quality analysis information.

In some embodiments, the water quality measurements are provided concurrently with a tag conveying water flow status information conveying an indicate of water flow through the monitoring device 140 when the water quality measurements were obtained. In such embodiments, deriving the water quality analysis information for may include processing the included tag conveying the water flow status information when the water quality measurements were obtained to modulate the derived water quality analysis information based on such tag. For example, in some embodiments, water quality measurements obtained when the water flow status information conveys a water flow below a threshold may be assigned a different weighting (for example a lower weighting), or be omitted entirely, in calculations used to derive the water quality analysis information.

As described earlier, in some embodiments, the water flow status information and the pump activation status may be used independently from one another, or in combination, to identify potential problems in the circulation system for example that there is something wrong with the pump 112 and/or there is a flow restriction somewhere in the circulation system resulting in insufficient water flow for the purpose of obtaining valid water quality measurements. For example, in some embodiments the server 180 may trigger a notification when the water quality measurements indicate that the pump has been active for at least a certain amount of time and the water flow status for water flow through the monitoring device is below an expected threshold.In the example of implementation shown in FIG. 1, the monitoring device 140 is associated to a communication module 150 that is in communication with the bathing unit controller 122. In alternative examples of implementation, some or the entirety of the functionality of the communication module 150 may be incorporated into a bathing unit controller, such as the bathing unit controller 122, configured for controlling multiple bathing unit components in a bathing unit system.

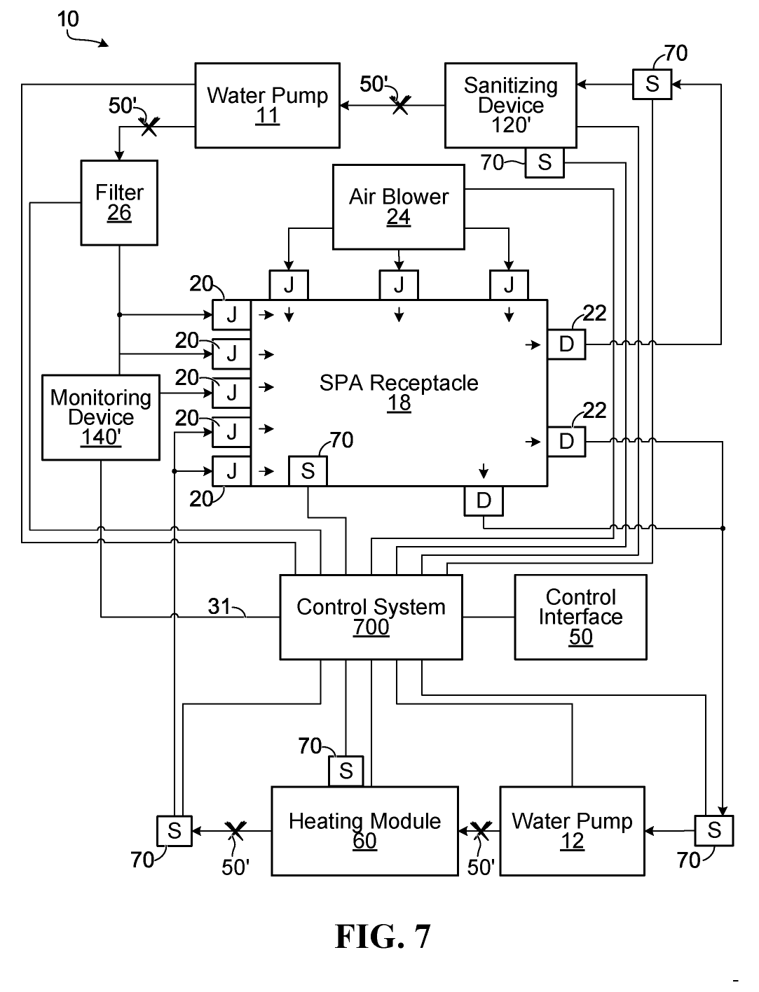

FIG. 7 is a block diagram of a bathing unit system 10 incorporating an alternative specific example of implementation of the invention. As depicted, the bathing unit system10 includes a bathing unit receptacle 18 for holding water, a plurality of jets 20, a set of drains 22, a heating module 60, two water pumps 11 & 12, a filter 26, an air blower 24, a sanitizing device 13 and a control system 700. It should be understood that in other alternative implementations, the bathing unit system 10 could include more or fewer bathing unit components. The bathing unit system 10 also includes a user control interface 50, such as a top side control panel, for enabling a user to provide commands for controlling the operational settings of the components in the bathing unit system 10 and optionally for conveying information related to the bathing unit system 10 to the user. In this alternative specific example of implementation of the invention, monitoring device has been denoted as monitoring device 140’ for the sake of clarity but may be configured as monitoring device 140 described with reference to FIG. 1. In this alternative example, the functionality of the communication module 150 (shown in FIG. 1) is incorporated (in totality or in part) into control system 700 configured for controlling operational settings in bathing unit system 10. Control system 700 is configured for communicating with monitoring device 140’ and with remote devices and/or services such as the remote devices 182 and remote server 180 shown in FIG. 1 (not shown in FIG. 7 for the sake of simplifying the drawing).In the example depicted, the monitoring device 140’ is located in the circulation piping of the bathing unit system 10 in fluid communication with sanitizing device 13, water pump 11 and filter 26. It will be appreciated by the person skilled in the art that the monitoring device 140’ may be located elsewhere in the circulation piping of the bathing unit system 10. Some non-limiting examples of alternative locations for the monitoring device 140’ have been identified with reference numeral 50’ in FIG. 7.

In some embodiments, in addition to the one or more water quality sensors in the monitoring device 140’ the control system 700 of the bathing unit system 10 may also receive operational signals from various sensors 70, which may include flow sensors, bathing unit cover status sensors, water temperature sensors, ambient temperature sensors and other sensors for measuring various parameters that may be useful in the control of the bathing unit system 10. Examples of manners in which the control system 700 can control the individual bathing unit components of the bathing system 10, such as for example the jets 20, the drains 22, the heating module 60, the water pumps 11 and 12, the filter 26, the air blower 24, a valve jet sequencer for massage, a variable speed pump with a pre-programmed massage setting, a water fall, an aroma therapy device and an atomizer, as well as any lighting and multimedia components, are beyond the scope of the present disclosure and as such will not be described in further detail here.

In other embodiments, not shown in the Figures, the communication module 150 and/or the monitoring device 140 and the remote server 182 may be configured for issuing signals to the bathing unit controller 122 requesting activation of the pump 112 for the purpose of obtaining water quality measurements. For example, the communication module 150 or the monitoring device 140 may be configured for periodically taking water quality measurements, say every 15min/30min/1h etc…. In such an embodiment, if the pump 112 is inactive when water quality measurements are to be taken, the communication module 150 or the monitoring device 140 may be configured for issuing command signals to the bathing unit controller 122 requesting activation of the pump 112. The bathing unit controller 122 may be responsive to such signal2 requesting activation of the pump 112 to issue a signal an activate the pump 112 for a time duration sufficient to allow water quality measurements to be taken and sent by the communication module 150.

The embodiments described above are intended to be exemplary only.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the invention have been described and illustrated, it will be apparent to those skilled in the art in light of the present description that numerous modifications and variations can be made. The scope of the invention is defined more particularly in the appended claims.

1. A server for monitoring a bathing unit system, the bathing unit system including a bathing receptacle, a set of bathing unit components including a pump and a network-enabled water quality monitoring system, the pump being configured for alternating between an activated state and a deactivated state in response to control signals received from the bathing unit controller, wherein in the activated state the pump is configured for causing water to circulate through a circulation system of the bathing unit system, said server comprising one or more processing units programmed for:
a. receiving, from the water quality monitoring system, water quality measurements, the water quality measurements including corresponding tags conveying activation status information for the pump of the bathing unit system when the water quality measurements were obtained, the activation status for the pump conveying one of the activated state and the deactivated state;
b. processing the water quality measurements to derive water quality analysis information conveying at least one of:
1. water quality analysis date; or
2. recommendations to initiate one or more actions for regulating water quality within the bathing unit system, said recommendations conveying at least one of an addition of an amount of sanitizer to the bathing unit system, an addition of a PH increaser solution, an addition of a PH reducer solution or an addition of an amount of water the bathing unit system;
wherein processing the water quality measurements to derive the water quality analysis information includes deemphasizing a set of water quality measurements corresponding to tags conveying that the pump was in the deactivated state when water quality measurements in said set of water quality measurements were taken relative to other water quality measurements; and
c. transmitting the water quality analysis information to at least one of:
i. the water quality monitoring system of the bathing unit system; or
ii. a user device associated with a user of the bathing unit system.

2. The server defined in claim 1, wherein processing the water quality measurements to derive the water quality analysis information includes discarding the set of water quality measurements corresponding to tags conveying that the pump was in the deactivated state when water quality measurements in said set of water quality measurements were taken.

3. The server defined in claim 1, wherein:
the set of bathing unit components of the bathing unit system includes a sanitizer for adding a sanitizing agent to water of the bathing unit system, the sanitizer being configured for alternating between an activated state and a deactivated state, wherein in the activated state the sanitizer is configured for adding a sanitizing agent to the water circulating through the circulation system;wherein the tags corresponding to the water quality measurements further convey an activation status for the sanitizer when the water quality measurements were obtained, the activation status for the sanitizer conveying one of the activated state and the deactivated state; andwherein processing the water quality measurements to derive the water quality analysis information includes modulating interpretation of the water quality measurements at least in part based on the activation status for the sanitizer when the water quality measurements were obtained at least in part by processing the one or more tags.

4. The server defined in claim 1, wherein the tags corresponding to the water quality measurements further convey activation status information for one of more bathing unit components in the set of bathing unit components when the water quality measurements were obtained; and wherein processing the water quality measurements to derive the water quality analysis information includes modulating interpretation of the water quality measurements at least in part based on the activation status information for the one of more bathing unit components when the water quality measurements were obtained at least in part by processing the one or more tags.

5. The server defined in claim 2, wherein:
a. wherein the set of bathing unit components includes a heater for heating the water within the circulation system, the heater being configured for alternating between an activated state and a deactivated state, wherein in the activated state the heater is configured for heating water in the circulation system;b. wherein the tags corresponding to the water quality measurements further convey activation status information for the heater when the water quality measurements were obtained, the activation status for the heater conveying one of the activated state and the deactivated state; andc. wherein processing the water quality measurements to derive the water quality analysis information includes modulating interpretation of the water quality measurements at least in part based on the activation status for the heater when the water quality measurements were obtained at least in part by processing the one or more tags.

6. The server defined in claim 1:
wherein the tags corresponding to the water quality measurements further convey activation status information for the blower when the water quality measurements were obtained, the activation status for the blower conveying one of the activated state and the deactivated state; and
wherein processing the water quality measurements to derive the water quality analysis information includes modulating interpretation of the water quality measurements at least in part based on the activation status for the blower when the water quality measurements were obtained at least in part by processing the one or more tags.

7. The server defined in claim 1, wherein the bathing unit system further includes a bathing unit cover for covering the bathing receptacle:
wherein the tags corresponding to the water quality measurements further convey a status for the bathing unit cover when the water quality measurements were obtained; and
wherein processing the water quality measurements to derive the water quality analysis information includes modulating interpretation of the water quality measurements at least in part based the status of the bathing unit cover when the water quality measurements were obtained at least in part by processing the one or more tags.

8. The server defined in claim 1:
wherein the bathing unit system includes one or more flow sensors configured to obtain water flow measurements at one or more locations within the circulation system of the bathing unit system;
wherein processing the water quality measurements to derive the water quality analysis information includes modulating interpretation of the water quality measurements at least in part based on the water flow status information when the water quality measurements were obtained at least in part by processing the one or more tags.
